(19) United States
(12) Patent Application Publication
(10) Pub. No.: US 2007/0234632 A1
(43) Pub. Date: Oct. 11, 2007

(54) Reelback

(76) Inventor: Charles Douglas Strickland, Old Town, FL (US)

Correspondence Address: Charles Strickland, 13704 Maria Drive, Hudson, FL, 34667, US

(21) Appl. No.: 11/520,187

(22) Filed: Sep. 13, 2006

Related U.S. Application Data
(60) Provisional application No. 60/790,832, filed on Apr. 11, 2006.

(51) Int. Cl. A01K 87/00; A01K 97/00; B63B 22/08; A01K 73/00

(52) U.S. Cl. 43/25; 441/7; 43/8; 43/23

(57) ABSTRACT

Herein known as REELBACK this device has been designed to retrieve lost items such due to separation from user, vessel, pier or persons such as fishing gear or other non-aquatic device.

This device is of suitable materials containing herein a preloaded retrieval device, housed with a deployable flotation device, allowing recovery of fishing gear or non aquatic items such as binoculars, keys, rods with reels, dip-nets, etc. items lost at sea, lakes, ponds and other bodies of water.

This application claims priority for provisional patent application 60/790,832

### BACKGROUND OF THE INVENTION

Lost fishing gear is a problem with great financial and environment consequences. Rods with Reels containing fishing line and dip-nets, for example, are frequently lost due to boating and fishing accidents. This problem is largely a financial problem, and the damages are easily calculated.

With respect to other types of fishing gear, such as floating gear, there is a significant environmental consequence in addition to the financial losses associated with lost gear. Dip-nets can be lost, for example, due to storms, rough seas, boating and fishing hazards, un-attended fishing gear, and strikes by fish, or user carelessness. Dip-nets and rods with reels containing monofilament lost in this manner “continue to fish” once lost. That is, fish and other animals (birds, turtles, etc . . . ) trapped within the net and fishing line die within the net or line entanglement. These dead and decaying fish and animals serve to attract more fish to the site to face the same consequences. This phenomenon has been referred to as “ghost fishing.”

It has been observed that the quantity of gear lost at sea world-wide, and continuing to fish, exceeds the gear currently in use by many-fold. A device that would assist in the recovery of such lost gear would be a great benefit to the User, as well as to the populations of the sea.

### SUMMARY OF THE INVENTION

The present invention relates to a fishing gear recovery device and methods of use. The fishing gear recovery device of the present invention includes a recovery line housing, which is preferably produced from non-flexible tubular plastic stock. Attachments points are provided in the recovery line housing for the attachment of a recovery line, and biodegradable connectors. Additionally, the recovery device includes a buoyancy providing element.

### BRIEF DESCRIPTION OF THE DRAWINGS

FIG. 1 is a perspective view of the fishing gear recovery device of the present invention.

### DETAILED DESCRIPTION OF THE INVENTION

The present invention relates to a fishing gear recovery device. In preferred embodiments, the fishing gear recovery device of the present invention includes: a) a recovery line housing; b) attachment points in the recovery line housing for a recovery line and biodegradable connectors; and c) a buoyancy providing element.

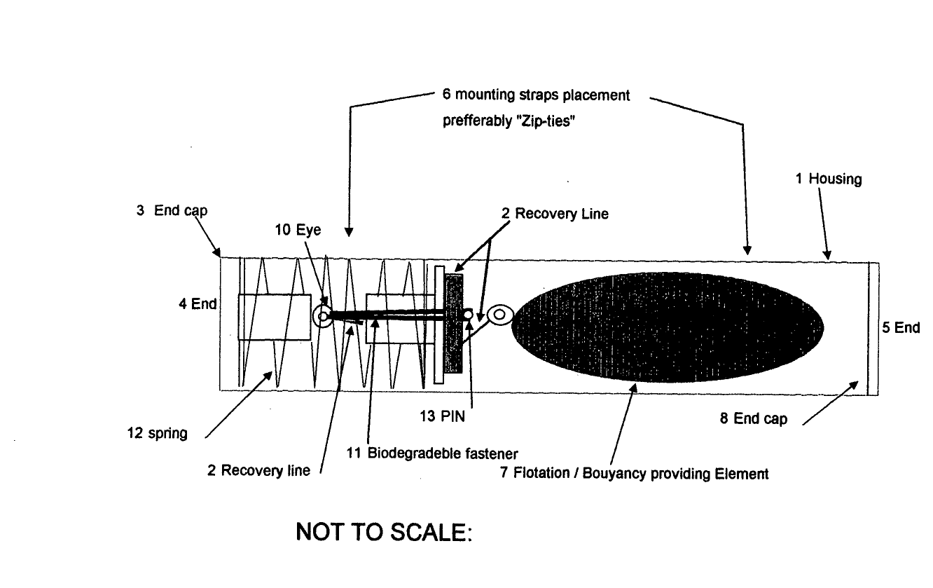

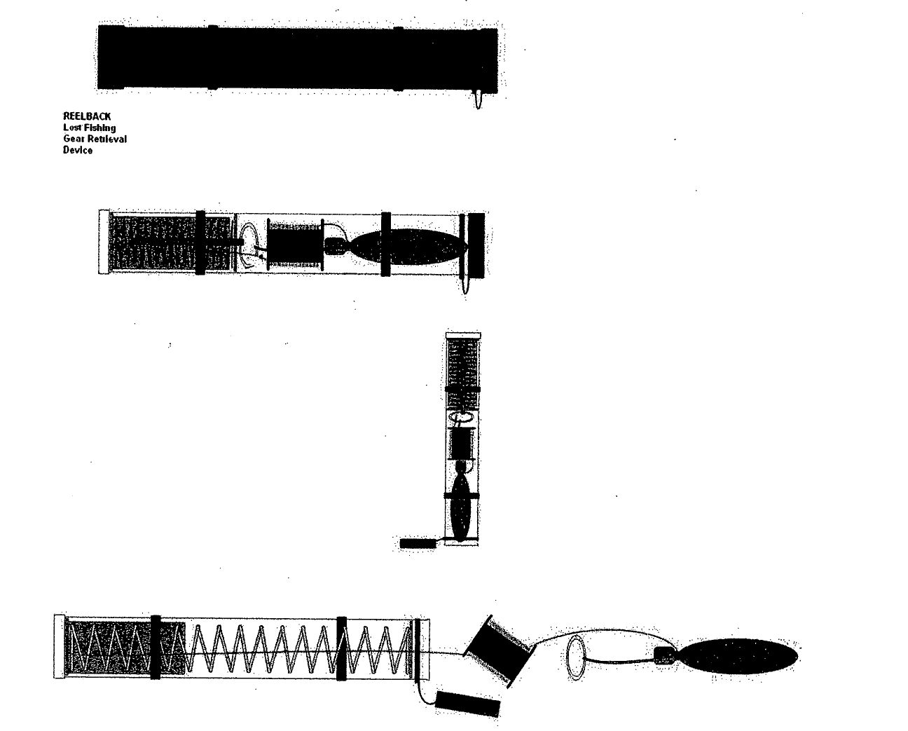

Referring to FIG. 1, preferred embodiments of the present invention include a recovery line housing (1) which is produced from materials such as tubular stock preferably UV-resistant plastic. It will be recognized that the tubular shape is non-critical, but practical and convenient. Consider, for example, housing with a flotation device of compact size able to surface a recovery line for retrieval of a Fishing rod from a depth of 200 feet or less.

For such an application, a recovery line (2), having a breaking strength of at least about 10 pounds, is appropriate. While such a recovery line may be supplied with the recovery device, many fishermen have individual depth preferences with respect to gear type or depth. Therefore, the recovery device will be offered in a preloaded form (i.e., containing a recovery line) and an end user may use the recovery device with a length/strength of a recovery line of choice.

Plastic type tubing having a diameter of about ½ to ¾ inch and a length of about 6-10 inches provides an interior volume sufficient to house such a recovery line, with sufficient additional volume available for purposes of providing buoyancy. Non-Flexible, plastics are best suited for this application. PVC, HDPE, CPVC and plastics having similar properties are examples of plastic material particularly well suited for use in production of the housing.

Referring again to FIG. 1, preferred embodiments of the gear recovery device include a adhered cap (3) at a first end (4) of the housing (1) to ensure recovery line deployment takes place from the opposite end (5) of the housing (1) which has a gear when not in use cap (8). The housing is also provided with one or more mounting straps (6) for the purpose of attaching the housing to the rod or gear to be recovered, if lost. Preferably, a plurality of mounting straps (6) is not provided. FIG. 1 shows area (6) for 2 mounting straps (6) on each end (4 and 5) of the recovery device housing (1). When a plurality of straps are provided at opposite ends of the device, as shown in FIG. 1, the gear recovery device can be securely attached and will not flop about during handling, which could result in accidental removal or deployment of the device.

The mounting straps are fitted with non-biodegradable fasteners. Such as zip-tie fasteners include a UV resistant type, known in the industry as “Zip-ties.” The non biodegradable fasteners (6) are attached to a secure portion of the fishing gear, such as the rod portion of a rod with reel, or a handle portion of a dip-net. The non-biodegradable fasteners (6) are replaced on a rotating basis. The replacement of these fasteners on a rotating basis which will be as retrieval device is used and new device installed. (i.e. once the device is activated by submersion of results of lost gear)

A buoyancy-providing element (7) is an essential element of the gear recovery device. For relatively shallow water application (e.g., about 200 feet or less), a high density foam type material will provide sufficient buoyancy. Examples of suitable high-density foams include, for example, PVC foam, styrene foam and urethane foam. Such foams may be fit within the housing.

In use, retrieval line (2) is loaded into the recovery device housing (1) through the adhered or factory sealed end (4). One end of the recovery line (2) is secured to the device housing. This can be accomplished by simply tying off one end of the recovery line to the eye (10) provided in the housing (1). The recovery line at the other end shall be attached to a flotation device or buoyancy providing element (7). The buoyancy provided element or flotation device will be ejected from housing (1) by spring pressure (12) when biodegradable fastener (11) degrades under submersion. The spring (12) is loaded under pressure and held in place by a suitable material such as plastic hereby referred to as a pin (13). The buoyancy provided element (7) carries the recovery line (2) to the surface. The other end of the recovery line attaches to (the loading end) of the device and is subsequently secured to a rod or dip-net when the device is attached which allows recovery of lost gear. Non-biodegradable fasteners (6) attach the gear recovery device to fishing gear. Preferably, the recovery device is attached to the rod for example, such that the housing (1) is horizontally or in parallel orientation when the rod is positioned as it is intended to be positioned during use. End (5) is preferably positioned at the bottom in this parallel orientation with end (4) being positioned at the top. The mounting of the recovery device to the rod in this orientation reduces the likelihood of line fouling which would prevent the recovery device flotation device from reaching the surface following degradation of the biodegradable fasteners (11).

The rate of degradation of such biodegradable fasteners (11) is dependent upon a variety of factors including, for example, temperature and salinity. Typically, such fasteners maintain their integrity for a period of months. It may be possible, however, to produce such fasteners from a gauge of material which will result in degradation under conditions of use within a period of minutes, or even hours. The use of an end cap (5) when gear is stowed away without fear of loss allows minimizing the risk of unwanted deployment (i.e., deployment from gear which has not been lost).

If a rod with reel or dip-net is lost, the recovery device will remain attached to the handle while the buoyancy provided element and spooled line return to the surface and the gear is recovered. Then the recovery unit and components will be removed after recovery. At that time, the unit must be replaced.

The recovery line is attached at one end to the recovery line housing, and at the other end, to the buoyancy provided element. In preferred embodiments, the color of the housing is highly visible. When gear is lost, a fisherman scans the surface in the area of the lost gear to find the buoyancy provided element. (7) Buoyancy provided element will surface to the top of the water.

In other embodiments, the present invention relates to methods for recovering lost fishing gear. The methods require the attachment of a fishing gear recovery device, of the type described above, to the gear prior to loss. Following loss, the fisherman searches the surface of the area of loss for a Buoyancy provided element attached to the recovery device. Upon location of the deployed device, the recovery line which tethers the recovery device to the gear is used to retrieve the lost gear.

What is claimed is:

1. A fishing gear or non aquatic recovery device for recovery of fishing gear lost due to separation from an associated surface vessel, pier, or persons, comprising:
2) a Pre-loaded recovery line housing produced from tubing stock for containing recovery line when the fishing gear recovery device is not deployed, the recovery line housing having a first sealed end for loading and an unsealed end for deploying the recovery line;
a) attachment points in the recovery line housing for:
i) a recovery line; and
ii) a single biodegradable connector which, are not replaceable on a rotating basis, one or more of the connectors being positioned to attach by looping thru an eye in the first unsealed end of the recovery line housing to prevent recovery line release when the recovery device is in a non-deployed state; and
c) a buoyancy providing element positioned within the recovery line housing;
wherein said biodegradable connectors do not degrade rapidly under conditions of use, but degrade quickly when submerged, in a period of minutes.

2. The fishing or non-aquatic gear recovery device of claim 1 wherein the recovery line housing is produced from a material such as UV-resistant plastic.

3. The fishing gear recovery device of claim 2 wherein the recovery line housing further comprises a first sealed end containing an adhered seal.

4. The fishing gear recovery device of claim 1 further comprising of a buoyancy providing element providing sufficient buoyancy to carry the line, such as fishing line which is housed within the recovery device to the surface when released from a depth of about 150 feet or less.

5. The fishing gear recovery device of claim 4 wherein the buoyancy providing element is produced from materials such as high density foam, polystyrene, cork, etc.

6. The fishing gear recovery device of claim 5 wherein buoyancy providing element is selected from the group consisting of materials such as PVC foam, styrene foam, urethane foam, cork materials, etc.

7. The fishing gear recovery device of claim 1 further comprising a buoyancy providing element providing sufficient buoyancy to carry the gear retrieval line housed within the recovery device to the surface when released from a depth of about 5 up to about 200±Feet.
